(19) United States
(12) Patent Application Publication
(10) Pub. No.: US 2024/0227738 A9
(43) Pub. Date: Jul. 11, 2024

(54) Nozzle System for Cleaning a Vehicle Part, In Particular a Window of a Motor Vehicle, and Cleaning Method

(71) Applicant: Bayerische Motoren Werke Aktiengesellschaft, Muenchen (DE)

(72) Inventors: Maximilian BEITELSCHMIDT, Weyarn (DE); Tobias BIALETZKI, Pleinfeld (DE)

(21) Appl. No.: 18/546,889

(22) PCT Filed: Jan. 31, 2022
(86) PCT No.: PCT/EP2022/052219

§ 371 Date: Aug. 17, 2023

(30) Foreign Application Priority Data
Feb. 18, 2021 (DE) 10 2021 103 869.3

(51) Int. Cl. B60S 1/52; B60S 1/48; H05B 3/56

(52) U.S. Cl. CPC B60S 1/52; B60S 1/488; H05B 3/56; H05B 2203/02

(57) ABSTRACT

A nozzle system for cleaning a vehicle part of a motor vehicle includes a nozzle body having a nozzle for applying a cleaning liquid to the vehicle part. A fluid line arrangement is configured for connection to a fluid-based cleaning system of the motor vehicle in order to conduct the cleaning liquid to the nozzle body. An electrically conducting heating wire runs through the fluid line arrangement and through the nozzle body. The heating wire has a first portion with a first cross section and a second portion with a second cross section where the first cross section is larger than the second cross section.

### BACKGROUND AND SUMMARY OF THE INVENTION

The invention relates to a nozzle system for cleaning a vehicle part and to a method for cleaning a vehicle part. The vehicle part is in particular a window of a motor vehicle.

For the cleaning of vehicle parts and in particular of vehicle windows, nozzle systems are used in many cases. By way of example, in various classes of motor vehicles, what are referred to as nozzle chains having a plurality of nozzles are installed on the underside of the front flap of the vehicle, in order to ensure the cleaning of the front window of a motor vehicle with the aid of a washing or cleaning liquid. As a result, washing water can be applied to the front window by way of the nozzles upon the driver's request. In order to ensure a better function in the case of low temperatures or freezing over at the location where the washing fluid exits the nozzle body, the nozzle chains have a heating means.

Such nozzle chains with a heating function are mostly based on the PTC (Positive Temperature Coefficient) heating principle. In this case, a PTC element is located in each nozzle body. The PTC elements are electrically connected in series. One disadvantage of this heating concept is the relatively high costs of the PTC elements. A further disadvantage is that the installation of the PTC elements in the nozzle body is very complex, since this is effected by way of an adhesive bonding process. In particular, here a fully automated assembly is not possible.

As an alternative thereto, other heating concepts are often utilized which deviate from the PTC technology. These in many cases use a heating wire which is laid through the entire nozzle chain and which uniformly heats the entire nozzle chain, i.e., the nozzle body and the connecting hoses. Here, however, there is the disadvantage that it is not only the nozzle body, which is critical for the operation of the nozzle chain, that is heated but also the hose connectors between the nozzle bodies. This leads to a substantially higher energy consumption compared with PTC heating.

One example of a cleaning apparatus which is heated by means of a heating wire is described in the publication DE 10 2018 221 354 A1. In this case, a chamber which can be filled with a cleaning liquid and which can be hydraulically connected to at least one spray nozzle for the cleaning fluid is configured in a housing. A heatable heating wire projects into the chamber. In order to enable particularly rapid de-icing, a heat-conducting element for increasing the size of a heat-transferring convection area is arranged in the chamber.

As a further example, the publication DE 10 2015 215 932 A1 describes a nozzle system for cleaning a window of a motor vehicle, the nozzle system being attached to a wiper arm. The nozzle system comprises a nozzle for discharging a cleaning liquid, a tube, a valve and a heating wire. The nozzle, the valve and the tube form a channel which can be switched by the valve, wherein the heating wire is arranged in the tube.

Document DE 7431778 U describes an electrical heating device for spray nozzles of vehicle window washing apparatuses, having a heating wire which is attached in the bore of the spray nozzle.

It is the object of the invention to provide a nozzle system and a cleaning method for cleaning vehicle parts and in particular vehicle windows, the nozzle system being heated effectively, being able to be produced with little effort and at low costs and having only a low energy consumption during operation.

According to a first aspect of the invention, a nozzle system for cleaning a vehicle part and in particular a vehicle window is provided, comprising at least one nozzle body having a nozzle for applying a cleaning liquid to the vehicle part, a fluid line arrangement, which is configured for connection to a fluid-based cleaning system of the vehicle, in order to conduct the cleaning liquid to the nozzle body, and an electrically conducting heating wire which runs through the fluid line arrangement and through the at least one nozzle body, wherein the heating wire comprises portions which have different cross sections in dependence on their respective position in the nozzle system.

The invention makes it possible to heat the nozzle system in a particularly effective manner with low energy consumption. The energy introduced can be utilized efficiently at the location where it is actually required. In this case, the production effort is low and causes only small costs, since PTC elements which are relatively expensive and additionally also require high effort during installation are no longer required.

The basic idea of the invention is in particular that the heating wire has different cross sections depending on the position in the nozzle chain.

Advantageously, the heating wire has a smaller cross section in a region within the nozzle body than in a region of the fluid line arrangement outside of the nozzle body.

Preferably, the nozzle system has a plurality of nozzle bodies which are arranged one behind the other and are connected to one another by the fluid line arrangement. In this case, one or more nozzle bodies are designed in such a way that one part of the respectively fed cleaning liquid exits at the nozzle thereof, and another part of the cleaning liquid is forwarded to a nozzle element connected downstream in the flow direction.

Preferably, the fluid line arrangement comprises a plurality of portions which connect a plurality of nozzle bodies which are spaced apart from one another to one another. Advantageously, the portions of the fluid line arrangement and the nozzle bodies form a continuous fluid channel in which the heating wire in particular continuously extends.

In particular, the fluid line arrangement is formed by a hose system, wherein the nozzle bodies are connected by individual hose portions.

The heating wire advantageously runs through the entire hose system of the nozzle chain and through the nozzles themselves.

By way of example, the heating wire has a relatively great cross section in the region of hose pieces which form fluid lines and which for example connect the nozzles, whereas the cross section of the heating wire in the region of the nozzles is very small in relation thereto.

The different resistances of the heating wire in the regions of the thick and thin cross section have the effect that the heating wire is heated primarily only at the thin locations. These locations of thin cross section advantageously lie directly in the nozzle bodies themselves.

Advantageously, the diameter of the heating wire in the region of the one or more nozzle bodies is less than ⅕, preferably less than 1/10, and particularly preferably less than 1/20, of its diameter in the region of the fluid line arrangement.

According to a second aspect of the invention, a method for cleaning a vehicle part and in particular a vehicle window is specified, comprising the steps:
feeding a cleaning liquid through a fluid line arrangement to at least one nozzle configured in a nozzle body; and applying the cleaning liquid to the vehicle part by means of the nozzle; wherein the nozzle body is heated by a heating wire which runs in the fluid line arrangement as far as the nozzle body, and wherein, by means of different cross sections of the heating wire, significantly more heat energy is introduced in the region of the nozzle body than in the fluid line arrangement.

The invention in particular enables a low energy consumption, since targeted heating is effected at the locations of the nozzle bodies.

Preferably, the cleaning liquid is fed to a plurality of nozzle bodies by means of the fluid line arrangement, each of the nozzle bodies being heated in a targeted manner by means of the heating wire.

In particular, the cleaning method is carried out by means of a nozzle system according to the invention.

According to a further aspect of the invention, a motor vehicle is provided which comprises a cleaning system having a nozzle system according to the invention.

Advantages, details and features which are described in conjunction with one aspect of the invention also each mutually apply to the other aspects of the invention.

Exemplary embodiments of the invention will be explained in more detail below on the basis of drawings.

### BRIEF DESCRIPTION OF THE DRAWINGS

FIG. 1 shows a schematic view of a nozzle system according to a preferred embodiment of the invention, one of the nozzle bodies additionally being illustrated in an enlarged detail as a view from below;

FIG. 2 shows a schematic illustration of a motor vehicle which is equipped with a nozzle system according to a preferred embodiment of the invention; and

FIG. 3 shows a nozzle body having a nozzle which is surrounded by a cover.

### DETAILED DESCRIPTION OF THE DRAWINGS

In the figures, identical or mutually corresponding elements are denoted in each case by the same reference designations and therefore, if not expedient, will not be described anew. Furthermore, it is also possible for individual features or combinations of features from the different exemplary embodiments shown and described to constitute independent or inventive solutions or solutions according to the invention.

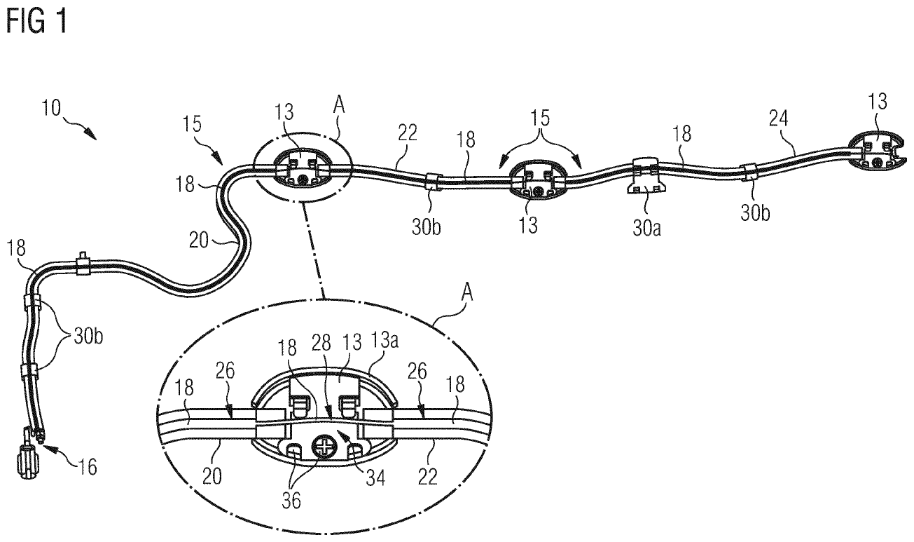

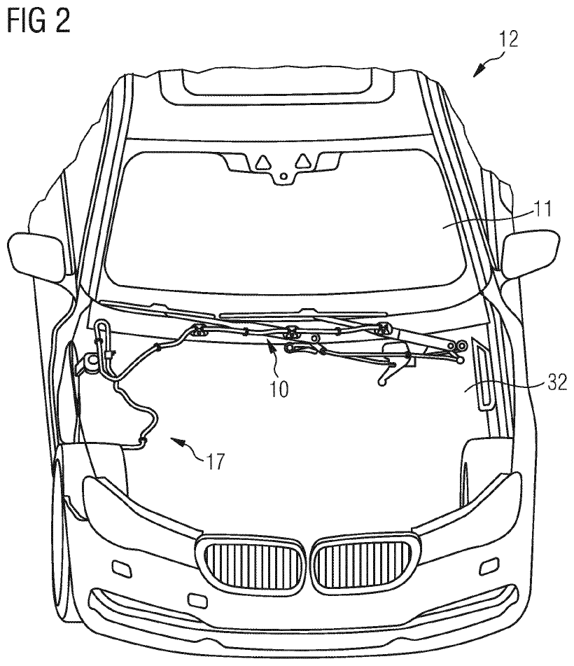

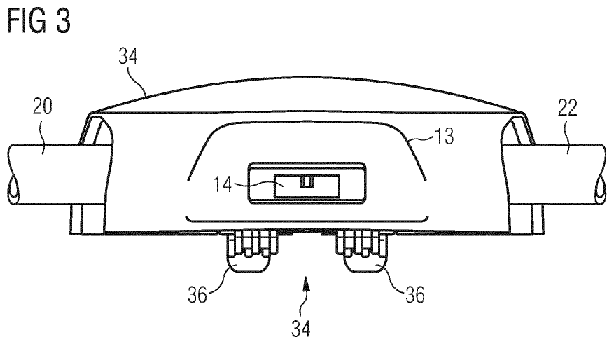

FIG. 1 shows a nozzle system 10 for cleaning a vehicle part according to a preferred embodiment of the invention. In the example illustrated here, the nozzle system 10 serves to clean a front window 11 of a motor vehicle 12, which is shown in FIG. 2. The nozzle system 10 forms a nozzle chain and has a plurality of nozzle bodies 13 in each of which a nozzle 14 is arranged, which is shown in FIG. 3, in order to spray a cleaning liquid onto the window 11 of the vehicle 12.

As shown in FIG. 1, the nozzle bodies 13 are connected to one another by a fluid line arrangement 15 which is designed to conduct the cleaning liquid, such as washing water, to the nozzle bodies 13. In this regard, the fluid line arrangement 15 is provided with a connection element 16 which is configured for connection to a fluid-based cleaning system 17 of the vehicle 12.

The fluid line arrangement 15 comprises a plurality of fluid lines or portions 20, 22, 24 which form a hose system and connect the nozzle bodies 13 which are spaced apart from one another to one another. The portions 20, 22, 24 configured as hose pieces form, together with the nozzle bodies 13 which each have a hollow space or channel for passage of the fluid, a continuous fluid channel.

A heating wire 18 extends in the fluid line arrangement 15 in the longitudinal direction thereof, the heating wire also running through each of the nozzle bodies 13. That is to say the heating wire 18 extends continuously in the longitudinal direction through the fluid channel. In this case, the heating wire 18 has portions with different cross sections in dependence on the position of the heating wire in the fluid channel and thus in the nozzle system or in the nozzle chain 10. That is to say different portions or sections or subregions of the heating wire 18 have different cross sections, wherein the cross section of the respective portion is dependent on its position in the nozzle system 10 or in the fluid channel.

The detail A, illustrated in enlarged form, in FIG. 1 shows an enlarged illustration of the first nozzle body 13 of the nozzle system 10 as a view from below, together with the line portions 20, 22 which adjoin both sides of the nozzle body 13 and are connected thereto, in order to conduct the cleaning fluid therethrough. The nozzle body 13 is surrounded at the side and at the top by a covering element 13a, while its underside 34 is exposed. The heating wire 18 has a substantially smaller cross section in the nozzle body 13 than in the line portions 20, 22 of the fluid line arrangement 15.

That is to say the heating wire 18 has a relatively great cross section in the region of the line portions 20, 22, 24, whereas the cross section of the heating wire 18 in the region of the nozzle bodies 13 and thus in the region of the nozzles 14 is very small.

The portions of the heating wire 18 in the region of the line portions 20, 22, 24 are labeled with the reference designation 26, while the portions of the heating wire 18 in the region of the nozzle body 13 are labeled with the reference designation 28.

The different electrical resistances of the heating wire 18, that is to say in the regions or line portions 22, 24, 26 with large or great cross section, on the one hand, and in the regions of the nozzle bodies 13 with thin or small cross section, on the other hand, have the effect that the heating wire 18 is heated primarily only at the thin locations, that is to say in the heating wire portions 28 which run in the nozzle bodies 13. These locations or portions 28 with a thin cross section advantageously lie directly in the nozzle bodies 13 themselves. In this way, the energy introduced can be utilized efficiently at the location where it is actually required.

The diameter of the heating wire 18 in the region of the nozzle bodies 13 or in the respective portion 28 is advantageously less than ⅕, preferably less than 1/10, and particularly preferably less than 1/20, of its diameter in the regions 26 of the fluid line arrangement 15.

As a result of the refinement of the heating wire 18 described here, a total energy input into the heating means or the heating wire which is many times lower is required in order to achieve the same heating power in the region of the nozzle bodies 13 as in the case of a nozzle system having a continuous heating wire which has a constant cross section, since the heating wire which has a constant cross section would be heated uniformly over its entire length.

The connection element 16 for connection of the nozzle chain or of the nozzle system 10 to the cleaning system 17 of the vehicle 12 is formed by a connecting piece in the form of a hose connector and by an electrical connection for electrically connecting the heating wire 18 to a voltage source not illustrated in the figures.

In order to fasten the nozzle chain 10 to the vehicle 12 or the vehicle body, fastening elements 30a, 30b are attached to the nozzle chain 10 and are fastened to the different portions 20, 22, 24 of the fluid line arrangement 15. The fastening elements 30a, 30b are configured, for example, as clamping elements or clips and serve to guide the fluid line arrangement or the hose, with the result that the latter can be or is fastened to the front flap 32 of the vehicle 12 and held there.

In addition, FIG. 3 shows a plan view of the nozzle 14 which is configured in the nozzle body 13 which is largely surrounded by the covering element 13a.

The underside 34 of the nozzle body 13 is configured as a bearing surface or in a plate-like manner. Projections 36 are configured on the underside 34 and engage into the metal sheet of the front flap 32 of the vehicle 12 for fastening of the nozzle chain 10.

The nozzle system according to the invention can be fastened to the vehicle 12 in various ways and can be used to clean a vehicle part, such as a front window. For example, the nozzle system may also be fastened, or used, for fastening to or in a wiper arm of the wiper system, in order to clean a vehicle window. In other embodiments, the nozzle system is designed to clean a rear window of a vehicle. In further embodiments, the nozzle system is configured to clean sensors or sensor surfaces, cameras and other vehicle parts. In general, the nozzle system can be used for water-based or fluid-based cleaning systems for cleaning parts or the surfaces thereof in vehicles.

In order to clean a vehicle part, a cleaning liquid is fed to the nozzle bodies 13 by means of the fluid line arrangement 15 of the nozzle system 10 and from there is applied to the vehicle part by means of the nozzle 14 which is arranged in the respective nozzle body 13. The vehicle part is, for example, the windshield or front window 11 of the vehicle 12. In this case, the heating wire 18 introduces significantly more heat energy in the region of the nozzle body 13 than in the region of the fluid line arrangement 15 or of the fluid line portions 20, 22, 24.

Different embodiments of the nozzle system are possible, for example having a plurality of nozzle bodies 13 as illustrated in the figures, or having only one nozzle body 13. In the case of a plurality of nozzle bodies 13, some of the nozzle bodies are designed such that the cleaning liquid flows through one or more nozzle bodies 13 in order to subsequently pass to one or more further nozzle bodies 13. When passing through the respective nozzle body 13, in each case part of the cleaning liquid is sprayed and/or injected through the nozzle 14 thereof or through a plurality of nozzles of the nozzle body onto the vehicle part or the window 11.

As a result of the invention, the effectiveness of the cleaning is increased, and at the same time a reduction in costs during the manufacture is achieved. There is a reduction in the energy consumption since the energy required for heating is selectively introduced where it is needed. In addition, the invention enables highly efficient cleaning nozzle systems for vehicles, without the need for PTC elements, such that, in addition to a significantly simpler, automated and therefore more cost-effective production, many more options for the supply of the structural elements are also available, which additionally increases the economic efficiency of the production.

### LIST OF REFERENCE CHARACTERS

10 Nozzle system/nozzle chain
11 Window/front window
12 Motor vehicle
13 Nozzle body
13a Covering element
14 Nozzle
15 Fluid line arrangement
16 Connection element
17 Cleaning system
18 Heating wire
20, 22, 24 Portions of the fluid line arrangement/line portions
26 Portions of the heating wire in the region of the line portions
28 Portions of the heating wire in the region of the nozzle body
30a, 30b Fastening elements
32 Front flap
34 Underside
36 Projection

1.-9. (canceled)

10. A nozzle system for cleaning a vehicle part of a motor vehicle, comprising:
at least one nozzle body having a nozzle for applying a cleaning liquid to the vehicle part;
a fluid line arrangement which is configured for connection to a fluid-based cleaning system of the motor vehicle in order to conduct the cleaning liquid to the nozzle body; and
an electrically conducting heating wire which runs through the fluid line arrangement and through the nozzle body;
wherein the heating wire has a first portion with a first cross section and a second portion with a second cross section and wherein the first cross section is larger than the second cross section.

11. The nozzle system according to claim 10, wherein the second cross section is disposed within the nozzle body and the first cross section is disposed in a region of the fluid line arrangement that is outside of the nozzle body.

12. The nozzle system according to claim 10, wherein the fluid line arrangement comprises a plurality of portions which connect a plurality of nozzle bodies which are spaced apart from one another to one another and wherein the plurality of portions of the fluid line arrangement and the plurality of nozzle bodies form a continuous fluid channel in which the heating wire continuously extends.

13. The nozzle system according to claim 12, wherein the fluid line arrangement is formed by a hose system and wherein the plurality of nozzle bodies are connected by individual hose portions.

14. The nozzle system according to claim 11, wherein a diameter of the second portion of the heating wire is less than ⅕ of a diameter of the first portion of the heating wire.

15. A method for cleaning a vehicle part of a motor vehicle, comprising the steps of:
feeding a cleaning liquid through a fluid line arrangement to a nozzle configured in a nozzle body;
applying the cleaning liquid to the vehicle part by the nozzle; and
heating the nozzle body by a heating wire which runs in the fluid line arrangement;
wherein, by using different cross sections of the heating wire, more heat energy is introduced in a region of the nozzle body than in the fluid line arrangement.

16. The method according to claim 15, wherein the cleaning liquid is fed to a plurality of nozzle bodies by the fluid line arrangement and wherein each of the plurality of nozzle bodies are heated in a targeted manner by the heating wire.

17. The method according to claim 15, wherein the method is performed by the nozzle system according to claim 10.

18. A motor vehicle, comprising:
a cleaning system having the nozzle system according to claim 10.
